(19) United States
(12) Patent Application Publication
(10) Pub. No.: US 2025/0332628 A1
(43) Pub. Date: Oct. 30, 2025

(54) TAILORED BLANK MATERIAL, METHOD FOR MANUFACTURING SAME, AND PRESS-MOLDED ARTICLE

(71) Applicant: OSAKA UNIVERSITY, Osaka (JP)

(72) Inventors: Hidetoshi FUJII, Osaka (JP); Yoshiaki MORISADA, Osaka (JP); Kohsaku USHIODA, Osaka (JP); Hiroki FUJIMOTO, Tokyo (JP); Hiroyuki HIRATA, Tokyo (JP); Shinji KODAMA, Tokyo (JP)

(21) Appl. No.: 18/684,475

(22) PCT Filed: Aug. 3, 2022
(86) PCT No.: PCT/JP2022/029778

§ 371 Date: Aug. 9, 2024

(30) Foreign Application Priority Data
Aug. 20, 2021 (JP) 2021-134686

(51) Int. Cl. B21D 22/20; B23K 20/12

(52) U.S. Cl. CPC B21D 22/20; B23K 20/12

(57) ABSTRACT

Provided are: a tailored blank material that comprises a joining section with excellent formability and that is formed from metal materials of different strengths; and a method for manufacturing the tailored blank material simply and efficiently. Also provided is a press-molded article for which this tailored blank material is used. This method for manufacturing a tailored blank material is characterized in that one member and another member are joined by linear friction welding and in that the difference between the tensile strengths of the one member and the other member is at least 150 MPa. When the welding pressure applied during the linear friction welding is P, the temperature at which the tensile strength of the one member reaches P is T₁ (° C.), and the temperature at which the tensile strength of the other member reaches P is Y₂ (° C.), it is preferable for P to be set so that the difference between T₁ and T₂ is 100° C. or less.

### TECHNICAL FIELD

The present invention relates to a tailored blank material, a method for manufacturing the same, and a press-molded article by using the tailored blank material.

### BACKGROUND ART

In practical use, high-strength steel sheets for automobiles are sometimes processed by press forming or the like after manufacturing a tailored blank material by welding a plurality of steel sheets into a plate material. Therefore, the formability of not only the base material but also the joined portion is required.

However, hardening and/or softening occurs in the joined portions obtained by conventional welding techniques, and thus, it is impossible to provide the joined portion with the same level of formability as the base metal. In particular, as the strength of the target steel sheet increases, the difference in mechanical properties between the base material and the joined portion increases, and therefore the joined portion becomes a distinct singular point in structural design and processing processes.

On the other hand, for example, in Patent Document 1 (Japanese Unexamined Patent Publication No. 2014-83565), there is disclosed a method for manufacturing a tailored blank includes a welding step of welding thick and thin plates by making surfaces on the one side butt against each other in such a manner as to be flush with each other, and a remelting step of remelting a weld zone welded in the welding step, in the remelting step, a remelting scanning speed for remelting the weld zone and a heat input density are set at values at which annealing is applied to the weld zone to progress cooling of a remelting zone.

In the method for manufacturing a tailored blank described in Patent Document 1, it is said that “by reducing the remelting scanning speed, the time for heat to be conducted from the remelting part to the periphery of the remelting part during remelting is increased, and the heating area is expanded. By keeping a wide heated area around the weld at a high temperature, the temperature difference between the remelting area and the heating area can be reduced, the cooling rate of the remelting area can be slowed, and the weld is annealed. Cooling progresses at a rapid rate. By annealing and cooling the welded part in this way, the hardness of the joint can be reduced. Further, by remelting the unevenness formed on the surface of the welded portion during welding, the surface of the joint can be formed to be smooth. These can alleviate stress concentration on the joint and cracking of the joint.”

Further, in Patent Document 2 (Japanese Unexamined Patent Publication No. 2015-510453), there is disclosed a method for manufacturing a tailored blank by connecting plated steel sheet blank with different materials or different thicknesses by laser-welding blank by using a filler wire.

In the method for manufacturing a tailored blank described in Patent Document 2, it is said that “by manufacturing a tailored blank by using a filler wire designed in consideration of the penetration of the plating layer, the welded part has a full martensitic structure after hot stamping. As a result, a plating layer removal process and a re-plating process are not required when producing a tailored blank, resulting in cost savings and improved productivity.”

### PRIOR ART REFERENCE

### Patent Document

Patent Document 1: Japanese Unexamined Patent Publication No. 2014-83565
Patent Document 2: Japanese Unexamined Patent Publication No. 2015-510453

### SUMMARY OF THE INVENTION

### Problem to be Solved by the Invention

However, the methods for manufacturing tailored blanks disclosed in Patent Document 1 and Patent Document 2 mentioned above form the welded portions made of a molten solidified structure by fusion welding, and there is a limit to control the microstructure and mechanical properties of the welded portion. In common carbon steel materials, martensite is generated in welded portions, resulting in embrittlement and hardening. Further, during the fusion welding, the temperature is inevitably raised to a temperature higher than the melting point of the materials to be joined, so softening of the heat-affected zone becomes a problem, especially for metal materials having a high strength.

That is, the welded portion formed by the conventional welding method becomes a singular point having mechanical properties different from that of the base material, and it has been difficult to impart good formability to a tailored blank material containing the welded portion. In particular, in the case of tailored blank materials in which metal materials having different strengths are joined together, in addition to difficulty of forming good interface to be joined that has sufficient strength as well as isotropic mechanical properties without anisotropy that does not inhibit plastic deformation of the joined portion, it has been extremely difficult to control the mechanical properties of the joined portion.

In view of the problems in the prior arts as described above, an object of the present invention is to provide a tailored blank material having a joined portion with excellent formability and made of metal materials having different strengths, and to easily and efficiently manufacture the tailored blank material. Another object of the present invention is to provide a press-molded article by using the tailored blank material of the present invention.

### Means to Solve the Problems

In order to achieve the above objects, the present inventors have conducted intensive research on the formability of jointed portion in tailored blank materials and suitable joining methods, and has found that when using the linear friction-joining is extremely effective.

Namely, the present invention provides a method for manufacturing a tailored blank material, characterized in that
one member and the other member are subjected to linear friction-joining, and
a difference in tensile strength between the one member and the other member is set to 150 MPa or more.

By using the linear friction-joining, it is possible to obtain a good solid phase joined portion even for metal members having a difference in tensile strength of 150 MPa or more. Further, compared to the friction stir welding (FSW), which is a typical solid phase joining method, since an extremely thin and homogeneous joining area is formed in the plate thickness direction, it is possible to minimize the influence of the joined portion on the formability of tailored blanks. Here, from the viewpoint of the usefulness and applicability of the tailored blank material, it is more preferable that the difference in tensile strength between one member and the other member be 300 MPa or more.

FIG. 1 is a schematic diagram which shows the situation during the linear friction-joining. The linear friction-joining is a solid phase joining in which the frictional heat generated when the materials to be joined are rubbed against each other by linear motion is the main heat source. The material softened by the temperature rise is discharged as burrs from the interface to be joined to remove the oxide film formed on the interface to be joined, and the new surfaces are brought into contact with each other to obtain the joined portion.

The conditions for the linear friction-joining are not particularly limited as long as the effects of the present invention are not impaired, and various conventionally known joining conditions can be used, and when setting the joining pressure to a high value, the joining temperature is lowered to be able to obtain a narrower joining area. The frequency, amplitude, burn-off length, and the like may be appropriately adjusted depending on the type, size, shape, and the like of the materials to be joined.

Further, in the method for manufacturing a tailored blank material of the present invention, it is preferable that, assuming that a joining pressure applied at the linear friction-joining is, a temperature at which the tensile strength of the one member becomes the P is T₁ (° C.), a temperature at which the tensile strength of the other member becomes the P is T₂ (° C.), the P is set so that the difference between the T₁ and the T₂ is within 100° C. When the difference between T₁ and T₂ is within 100° C., even if the metal members have a difference in tensile strength of 300 MPa or more, both materials (the one member and the other member) are deformed in the vicinity of the interface to be joined during the linear friction-joining to be able to discharge a sufficient amount of burrs that are necessary for joining by butting the new surfaces. Here, the yield strength can also be used instead of the tensile strength.

Further, in the method for manufacturing a tailored blank material of the present invention, it is preferable that the one member and/or the other member are steel sheets, and the steel sheet has a tensile strength of 980 MPa or more. By using the linear friction-joining, it is possible to form a good solid phase joined portion even a high tensile steel material having a tensile strength of 980 MPa or more is used.

Further, in the method for manufacturing a tailored blank material of the present invention, it is preferable that the one member and/or the other member are a galvanized steel sheet. When the galvanized steel sheets are welded, the galvanizing components inevitably get mixed into the welded portion, which deteriorates the mechanical properties of the welded portion. On the other hand, in linear friction-joining, since the burr is discharged from the entire circumference of the joined interface to achieve the joining, even if the zinc plating evaporates or melts during the joining, it is possible to effectively suppress contamination of the galvanizing components into the joined portion. In particular, when linearly friction-joining the galvanized steel sheets, by linearly sliding the sheets in the direction perpendicular to the sheet thickness, the burrs can be quickly discharged from the long sides, which occupy most of the surface of the joined portion, and the contamination of the galvanized components into the joined portion can be very effectively suppressed.

Further, as a result of the present inventors' detailed observation of the linear friction joined portion of the galvanized steel sheets, it has been clearly found that the galvanized layer formed on the surface of the steel sheet deforms and/or moves following suitably softened burrs, so the linear friction joined portion is covered with a galvanized layer up to the root of the burr. That is, by using the linear friction-joining, not only the contamination of zinc into the joined portion can be suppressed, but also the surface of the joined portion can be sufficiently covered with the galvanized layer even after joining.

When the material to be joined is the galvanized steel sheet, the type, size and shape of the galvanized steel sheet are not particularly limited as long as the effects of the present invention are not impaired, and various conventionally known galvanized steel sheets can be used. Examples of the galvanized steel sheets include hot-dip galvanized steel sheets (GI), galvannealed steel sheets (GA), electrogalvanized steel sheets (EG) and double-layer alloyed galvanized steel sheets (GAE), and, a similar method can be applied to galvanized steel sheets having different compositions, such as highly corrosion-resistant hot-dip zinc-aluminum-magnesium alloy coated steel sheets (ZAM (registered trademark), Superdyma (registered trademark): high climate-resistant coated steel sheets), zinc-aluminum alloy coated steel sheets, zinc-nickel alloy coated steel sheets, zinc-magnesium coated steel sheets. Further, in each galvanized steel sheet, the coating weight (plating thickness) is not particularly limited as long as the effects of the present invention are not impaired, and can be set to various conventionally known values.

Furthermore, in the method for manufacturing the tailored blank material, it is preferable that the joining temperature is set to an A₁ point or less of the steel sheet. When the joining temperature is set to the A₁ point or less of the steel sheet, it is possible to suppress the softening and embrittlement of the steel sheet. Here, in the present invention, the “joining temperature” means the desired maximum temperature of the interface to be joined at the linear friction-joining. In the steel material having a high carbon content, such as medium or high carbon, there is a case that brittle martensite is formed by phase transformation to make joining difficult and to make the joined portion brittle. On the other hand, when the joining temperature is set to the A₁ point or less, since any phase transformation does not occur, the formation of the brittle martensite can be completely suppressed. In addition, by lowering the joining temperature, softening in the heat affected zone can be suppressed.

Here, the frictional heat increases when the applied pressure of the linear friction-joining is increased, but since the softened material becomes burrs and is continuously discharged, the “joining temperature” is determined by the pressure (force to discharge burrs) which is applied to the softened material. That is, when the applied pressure is set high, the material to be joined with higher strength (state with high yield strength) can be discharged as burrs. Here, since the “state with higher yield strength” means the “state with lower temperature”, the “joining temperature” decreases as the applied pressure increases. Since the relationship between the yield strength and the temperature is substantially constant depending on the material, the joining temperature can be controlled extremely accurately compared to the case where frictional heat is used.

Further, the present invention also provides a tailored blank material which has a linear friction joined portion where one member and the other member are integrated via a linear friction joined interface, and a difference in tensile strength between the one member and the other member is 150 MPa or more.

The tailored blank material of the present invention has the difference in tensile strength of the one member and the other member of 150 MPa or more, and can be suitably used as a tailored blank material when the required strength and plate thickness of each portion are greatly different. Further, since the one member is firmly joined to the other member via the linear friction joined portion with a narrow joining area compared to other solid phase joining methods, which improves the formability of tailored blanks, the influence of the joined portion on the formability of tailored blanks is extremely small. The difference in tensile strength between the one member and the other member is preferably 300 MPa or more.

In the tailored blank material of the present invention, it is preferable that the one member and/or the other member are steel sheets, and the steel sheet has a tensile strength of 980 MPa or more. Since the one member and/or the other member are made of high-tensile steel sheets having a tensile strength of 980 MPa or more, the blank material can be suitably used as structural members for automobiles and the like.

Further, in the tailored blank material of the present invention, it is preferable that the one member and/or the other member are a galvanized steel sheet. By using the galvanized steel sheet, it can be applied to members that require corrosion resistance, and can be suitably used, for example, as structural members for automobiles and the like.

Further, in the tailored blank material of the present invention, it is preferable that the Vickers hardness (H) of the linear friction joined interface is 1.1 times or less of the higher of the Vickers hardnesses of the one member and the other member, and 0.9 times or more of the lower of the Vickers hardnesses of the one member and the other member. By setting the Vickers hardness (H) of the linear friction joined interface within this range, it is possible to obtain a good joined portion having sufficient strength as well as isotropic mechanical properties without anisotropy that does not inhibit plastic deformation of the joined portion.

Further, in the tailored blank material of the present invention, it is preferable that the Vickers hardness (H) of the linear friction joined interface, the Vickers hardness (H₁) of the one member, and the Vickers hardness (H₂) of the other member satisfy the relationship of 0.8 [(H₁+H₂)/2]≤H≤1.2 [(H₁+H₂)/2].

In tailored blank materials in which metal materials having different strengths are joined, from the viewpoint of imparting good formability, it is preferable that the hardness of “the one member˜joined portion˜the other member” changes smoothly and continuously (not to make the joined portion a singular point). Here, when the Vickers hardness (H) of the joined portion is in the range of 0.8 to 1.2 times the average value of the Vickers hardness (H₁) of the one member and the Vickers hardness (H₂) of the other member, it is possible to effectively prevent the joined portion from becoming a singular point.

The tailored blank material of the present invention can be suitably obtained by using the method for manufacturing a tailored blank material of the present invention.

Furthermore, the present invention also provides a press-molded article characterized in that the linear friction joined portion of the tailored blank material is plastically deformed.

The linear friction joined portion of the tailored blank material of the present invention is not a singular point of the tailored blank material from the viewpoint of mechanical properties, and has good formability. As a result, the press-molded article of the present invention has no crack or wrinkle in the plastically deformed linear friction joined portion, and has a good appearance and high reliability.

### Effects of the Invention

According to the present invention, it is possible to provide a tailored blank material having a joined portion with excellent formability and made of metal materials having different strengths, and to easily and efficiently manufacture the tailored blank material. Further, it is also possible to provide a press-molded article by using the tailored blank material of the present invention.

### BRIEF DESCRIPTION OF THE DRAWINGS

FIG. 1 is a schematic diagram which shows the situation during the linear friction-joining.

FIG. 2 is a schematic diagram which shows the joining process of the linear friction-joining of the present invention.

FIG. 3 is a graph which shows the deformation stress (yield stress) of the carbon steel at each temperature.

FIG. 4 is a graph which shows the tensile strength of various metals at each temperature.

FIG. 5 is a schematic cross-sectional view which shows one example of the tailored blank material f the present invention.

FIG. 6 is a schematic cross-sectional view which shows one example of the press-molded article of the present invention.

FIG. 7 is the base material structure of the 590 MPa class high strength steel sheet used in Examples.

FIG. 8 is the base material structure of the 980 MPa class high strength steel sheet used in Examples.

FIG. 9 is the base material structure of the 1250 MPa class high strength steel sheet used in Examples.

FIG. 10 is a graph which shows the temperature dependence of the strength of each high strength steel sheet used in Examples.

FIG. 11 is a cross-sectional macro photograph of the example 590/980 joint.

FIG. 12 is a cross-sectional macro photograph of the example 590/1250 joint.

FIG. 13 is a cross-sectional macro photograph of the comparative 590/980 joint.

FIG. 14 is a cross-sectional macro photograph of the comparative 590/1250 joint.

FIG. 15 is a photograph of the microstructure in the vicinity of the linear friction joined interface of the example 590/980 joint.

FIG. 16 is a photograph of the microstructure in the vicinity of the linear friction joined interface of the example 590/1250 joint.

FIG. 17 is a photograph of the microstructure in the vicinity of the linear friction joined interface of the comparative 590/980 joint.

FIG. 18 is a photograph of the microstructure in the vicinity of the linear friction joined interface of the comparative 590/1250 joint.

FIG. 19 is a Vickers hardness distribution of the example 590/980 joint and the comparative 590/980 joint.

FIG. 20 is a Vickers hardness distribution of the example 590/1250 joint and the comparative 590/1250 joint.

FIG. 21 is a schematic view of the Erichsen test.

FIG. 22 s the Erichsen test results of the example 590/980 joint and the comparative 590/980 joint.

FIG. 23 is the Erichsen test results of the example 590/1250 joint and the comparative 590/1250 joint.

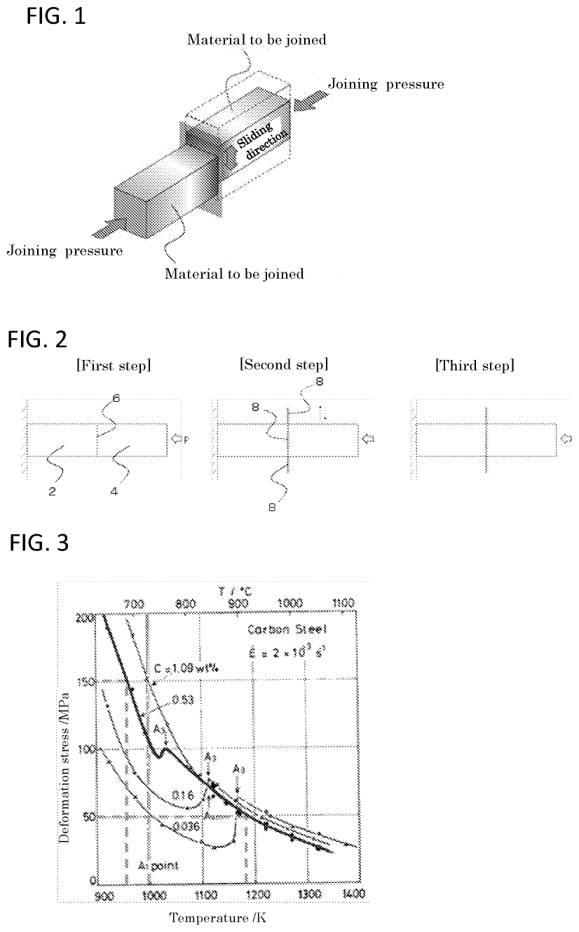

### MODE FOR CARRYING OUT THE INVENTION

In the following, by referring the drawings, the typical embodiments of the tailored blank material of the present invention, the method for manufacturing the tailored blank material, and the press-molded article by using the tailored blank material are explained, but the present invention is not limited thereto. In the following explanation, the same symbol is given to the same or corresponding parts, and there is a case where overlapping explanation is omitted. In addition, since these drawings are presented to explain the concept of the present invention, there are cases where size and ratio of the structural elements are different from the real case.

### (1) Method for Manufacturing Tailored Blank Material (Linear Friction-Joining Method)

FIG. 2 is a schematic diagram which shows the joining process of the linear friction-joining in the present invention. The linear friction-joining includes of a first step of bringing the one member 2 into contact with the other member 4 to form an interface 6 to be joined, a second step of repeatedly sliding the one member 2 and the other member 4 on the same locus a state while applying a pressure substantially perpendicular to the interface 6 to be joined to discharge the burr 8 from the interface to be joined substantially parallel to and substantially perpendicular to the sliding direction, and a third step of forming a joining surface by stopping the sliding. Hereinafter, each step will be described in detail.

### (1-1) First Step

The first step is a step of bringing the one member 2 into contact with the other member 4 to form an interface 6 to be joined. The one member 2 and/or the other member 4 is moved to a position where the formation of the joined portion is desired, and the surfaces to be joined are brought into contact with each other to form the interface 6 to be joined. The shape and size of the one member 2 and the other member 4 are not particularly limited as long as the effects of the present invention are not impaired, and the shape and size of the one member 2 and the other member 4 may be different. Further, the shape and size of the end face having the interface to be joined 6 may be different between the one member 2 and the other member 4.

The method for manufacturing a tailored blank material of the present invention is characterized in that the difference in tensile strength between the one member 2 and the other member 4 is 150 MPa or more. Further, it is preferable that the difference in tensile strength is 300 MPa or more. When the difference in strength between the one member 2 and the other member 4 is large, it is very difficult to avoid the joined portion from becoming a singular point in mechanical properties. However, in addition to making the width of the joined portion extremely narrow by using the linear friction-joining, by controlling the joining temperature (lowering the temperature) to effectively suppress the hardening caused by the formation of martensite and the softening of the heat-affected zone, a good tailored blank material can be obtained.

Further, it is preferable that the one member 2 and/or the other member 4 are steel sheets, and the steel sheet has a tensile strength of 980 MPa or more. By using the linear friction-joining, it is possible to form a good solid phase joined portion even a high tensile steel material having a tensile strength of 980 MPa or more is used. Here, a more preferable tensile strength of the steel sheet is 1180 MPa or more.

Further, it is preferable that the one member 2 and/or the other member 4 are made of a galvanized steel sheet. When the galvanized steel sheets are welded, the galvanizing components inevitably get mixed into the welded portion, which deteriorates the mechanical properties of the welded portion. On the other hand, in linear friction-joining, since the burr is discharged from the entire circumference of the joined interface to achieve the joining, even if the zinc plating evaporates or melts during the joining, it is possible to effectively suppress contamination of the galvanizing components into the joined portion. In particular, when linearly friction-joining the galvanized steel sheets, by linearly sliding the sheets in the direction perpendicular to the sheet thickness, the burrs can be quickly discharged from the long sides, which occupy most of the surface of the joined portion, and the contamination of the galvanized components into the joined portion can be very effectively suppressed.

Further, since the galvanized layer formed on the surface of the steel sheet deforms and/or moves following suitably softened burrs, the linear friction joined portion is covered with a galvanized layer up to the root of the burr. That is, by using the linear friction-joining, not only the contamination of zinc into the joined portion can be suppressed, but also the surface of the joined portion can be sufficiently covered with the galvanized layer even after joining.

When the material to be joined is the galvanized steel sheet, the type, size and shape of the galvanized steel sheet are not particularly limited as long as the effects of the present invention are not impaired, and various conventionally known galvanized steel sheets can be used. Examples of the galvanized steel sheets include hot-dip galvanized steel sheets (GI), galvannealed steel sheets (GA), electrogalvanized steel sheets (EG) and double-layer alloyed galvanized steel sheets (GAE), and, a similar method can be applied to galvanized steel sheets having different compositions, such as highly corrosion-resistant hot-dip zinc-aluminum-magnesium alloy coated steel sheets (ZAM. (registered trademark), Superdyma (registered trademark): high climate-resistant coated steel sheets), zinc-aluminum alloy coated steel sheets, zinc-nickel alloy coated steel sheets, zinc-magnesium coated steel sheets. Further, in each galvanized steel sheet, the coating weight (plating thickness) is not particularly limited as long as the effects of the present invention are not impaired, and can be set to various conventionally known values.

### (1-2) Second Step

The second step is a step of repeatedly sliding the one member 2 and the other member 4 on the same locus a state while applying a pressure P substantially perpendicular to the interface 6 to be joined to discharge the burr 8 from the interface 6 to be joined substantially parallel to and substantially perpendicular to the sliding direction.

The method of repeatedly sliding the one member 2 and the other member 4 on the same locus is not particularly limited as long as the effect of the present invention is not impaired, and may be a method in which both members are vibrated together, or a method in which one is vibrated while the other is fixed.

The conditions for the linear friction-joining are not particularly limited as long as the effects of the present invention are not impaired, and various conventionally known joining conditions can be used, and when setting the joining pressure to a high value, the joining temperature is lowered to be able to obtain a narrower joining area. The frequency, amplitude, burn-off length, and the like may be appropriately adjusted depending on the type, size, shape, and the like of the materials to be joined. Here, when increasing the frequency and/or amplitude, the temperature increasing rate and cooling rate can be increased, and softening of the heat-affected zone can be effectively suppressed. Further, as long as sufficient joining strength can be obtained by the contact between the new surfaces, when reducing the burn-off length, the joining time can be shortened and the thermal effects on the joined portion can be reduced. In addition, the joining time can also be shortened by increasing the frequency and amplitude.

Further, it is preferable that, assuming that a joining pressure applied at the linear friction-joining is P, a temperature at which the tensile strength of the one member 2 becomes the P is T₁ (° C.), a temperature at which the tensile strength of the other member 4 becomes the P is T₂ (° C.), the P is set so that the difference between the T₁ and the T₂ is within 100° C. When the difference between T₁ and T₂ is within 100° C., even if the metal members have a difference in tensile strength of 300 MPa or more, both materials (the one member 2 and the other member 4) are deformed in the vicinity of the interface to be joined during the linear friction-joining to be able to discharge a sufficient amount of burrs that are necessary for joining by butting the new surfaces. The difference between T₁ and T₂ is more preferably within 50° C., most preferably within 30° C.

Here, in the present invention, the joining temperature can be controlled by setting the pressure P at the time of the linear friction-joining to equal to or higher than the yield stress of the one member 2 and/or the other member 4 and equal to or lower than the tensile strength at a desired joining temperature. For example, by setting the pressure P to equal to or higher than the yield stress and lower than the tensile strength of the hot-dip galvanized steel sheet at the desired joining temperature, the joining temperature can be determined based on the hot-dip galvanized steel sheet. When the pressure P is set to equal to or higher than the yield stress of the hot-dip galvanized steel sheet, the discharge of burrs 8 from the interface 6 to be joined is started, and when the pressure P is increased up to the tensile strength, the discharge of burrs 8 is accelerated. Similar to the yield stress, since the tensile strength at a specific temperature is substantially constant depending on the material to be joined, the joining temperature corresponding to the set pressure P can be realized.

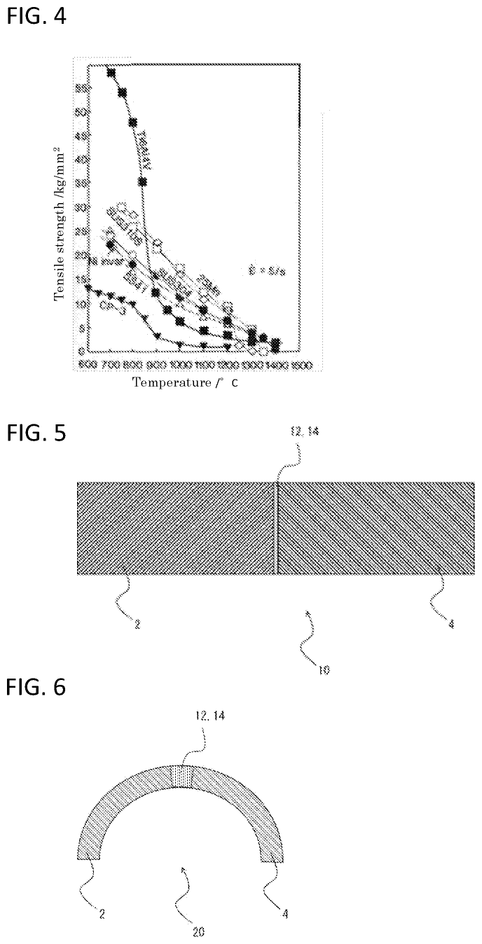

As a specific example, FIG. 3 shows the deformation stress (yield stress) of the carbon steel at each temperature, and FIG. 4 shows the tensile strength of various metals at each temperature. FIG. 3 is a graph published in “Iron and Steel, No. 11, the 67th year (1981), p. 140”, and FIG. 4 is a graph published in “Iron and Steel, No. 6, the 72th year (1986), p. 55”. As shown in these figures, the tensile strength and yield stress at a specific temperature are substantially constant depending on the material.

That is, when the pressure P at the time of joining is set high, the material to be joined having higher yield strength and tensile strength can be discharged as burrs, and the joining temperature can be lowered. Further, as shown in FIG. 3 and FIG. 4, since the tensile strength and the yield stress at a specific temperature are substantially constant depending on the material, by setting the joining pressure P on the basis of the temperature dependence of the strength of the materials to be joined the joining temperature can be controlled extremely accurately.

In the linear friction-joining, it is necessary to set joining parameters (frequency and amplitude for exciting the material to be joined, joining time, burn-off length, and the like) other than the pressure P, but these values are not limited as long as the effect of the present invention is not impaired, and may be appropriately set depending on the property, shape, size and the like of the material to be joined. Here, though the rate of temperature rise increases by increasing the amplitude and frequency at which the material to be joined is slid, the maximum temperature reached (joining temperature) does not change.

Further, when the one member 2 and/or the other member 4 is made of the steel material, it is preferable that the joining temperature is set to an A₁ point or less of the steel sheet. When the joining temperature is set to the A₁ point or less of the steel sheet, it is possible to suppress the softening and embrittlement of the steel sheet. In the steel material, there is a case that brittle martensite is formed by phase transformation to make joining difficult and to make the joined portion brittle. On the other hand, when the joining temperature is set to the A₁ point or less, since any phase transformation does not occur, the formation of the brittle martensite can be completely suppressed. In addition, by lowering the joining temperature, softening in the heat affected zone can be suppressed.

Furthermore, when one member 2 and/or the other member 4 is a galvanized steel sheet, the joining temperature is preferably set to equal to or lower than the boiling point of zinc (907° C.), and more preferably set to equal to or lower than the melting point of zinc plating. In linear friction-joining, the joining temperature can be accurately determined by the joining pressure P, but by setting the joining temperature to equal to or lower than the boiling point of zinc, it is possible to suppress changes in the galvanized layer formed on the surface of the steel sheet. Further, by setting the joining temperature to equal to or lower than the melting point of the zinc plaiting, changes in the galvanized layer can be suppressed more reliably.

### (1-3) Third Step

The third step is a step of stopping sliding in the second step to form a joined surface. In the linear friction-joining method of the present invention, a good joined article can be obtained by stopping the sliding after the burrs 8 are discharged from the entire surface of the interface 6 to be joined. Further, by discharging the burr 8 from the entire surface of the interface 6 to be joined, it is possible to suppress the zinc plating components from entering the joined portion. Note that, the pressure P applied to the material to be joined in the second step may be maintained as it is, or may be set to a higher value for the purpose of discharging the burr 8 and making the new surface being brought into contact more strongly.

Here, the timing to stop the sliding is not limited as long as the burr 8 has been discharged from the entire surface of the interface 6 to be joined, but, while observing the interface 6 to be joined from the direction substantially perpendicular to the sliding direction, by stopping the sliding at the moment when the burr 8 is discharged approximately parallel to the sliding direction, it is possible to form a good joined portion, while the amount of burr 8 discharged can be minimized (the consumption of the material to be joined can be minimized). Note that both the “direction substantially perpendicular to the sliding direction” and the “direction substantially parallel to the sliding direction” are substantially perpendicular to the applied pressure.

### (2) Tailored Blank Material

FIG. 5 is a schematic cross-sectional view which shows one example of the tailored blank material of the present invention. The tailored blank material 10 is formed by linearly friction-joining the one member 2 and the other member 4, and has a linear friction joined portion 14 where one member 2 and the other member 4 are integrated via the linear friction joined interface 12, and a difference in tensile strength between the one member 2 and the other member 4 is 150 MPa or more. Further, it is preferable that the difference in tensile strength between the one member 2 and the other member 4 is 300 MPa or more. Although FIG. 5 shows a case of butt joining where the size and shape of the ends to be linearly friction joined are the same, the tailored blank material of the present invention is not limited thereto, and the one member 2 and the other member 4 may have different sizes and/or shapes, and may be made of different materials.

The tailored blank material 10 has a difference in tensile strength between the one member 2 and the other member 4 of 150 MPa or more (preferably 300 MPa or more), and can be suitably used as a tailored blank material when the strength required in each portion is significantly different. Further, since the one member 2 and the other member 4 are firmly joined at the linear friction joined portion 14 (linear friction joined interface 12), which has a narrow joining area width compared to other solid phase joining methods, the influence of the joined portion to the formability of the tailored blank material is extremely small.

In the tailored blank material 10, it is preferable that the one member 2 and/or the other member 4 are steel sheets, and the steel sheet has a tensile strength of 980 MPa or more. Since the one member 2 and/or the other member 4 are made of high-tensile steel sheets having a tensile strength of 980 MPa or more, the blank material can be suitably used as structural members for automobiles and the like. Here, a more preferable tensile strength of the one member 2 and/or the other member 4 is 1180 MPa or more.

Further, in the tailored blank material 10 of the present invention, it is preferable that the one member 2 and/or the other member 4 are a galvanized steel sheet. By using the galvanized steel sheet, it can be applied to members that require corrosion resistance, and can be suitably used, for example, as structural members for automobiles and the like.

When the one member 2 and/or the other member 4 are the galvanized steel sheet, the linear friction joined portion 14 does not contain the components of the galvanized layer formed on the surface of the hot-dip galvanized steel sheet. It is sufficient to confirm that “zinc plating components are not mixed in the linear friction joined portion” by elemental analysis with SEM-EDS on the cross section of the joined portion, but, since the quantitative value of zinc causes an error due to the peak derived from iron, for example, elemental mapping may be obtained for the entire cross section of the joined portion, and the determination may be made based on whether or not a clear location of zinc is shown inside the joined portion.

Further, in the tailored blank material 10, the burrs 8 are formed at the outer edge of the linear friction joined interface 12 after the linear friction-joining, but when the one member 2 and/or the other member 4 are the galvanized steel sheet, the surface of the linear friction joined portion 14 is coated with the galvanized layer up to the root of the burr 8. Since the surface of the linear friction joined portion 14 is coated with the galvanized layer up to the root of the burr 8, it is possible to realize a joined portion having excellent corrosion resistance.

Further, in the tailored blank material 10, it is preferable that the Vickers hardness (H) of the linear friction joined interface 12 is 1.1 times or less of the higher of the Vickers hardnesses of the one member 2 and the other member 4, and 0.9 times or more of the lower of the Vickers hardnesses of the one member 2 and the other member 4. By setting the Vickers hardness (H) of the linear friction joined interface 12 within this range, it is possible to obtain a good joined portion having sufficient strength as well as isotropic mechanical properties without anisotropy that does not inhibit plastic deformation of the joined portion.

Further, in the tailored blank material 10, it is preferable that the Vickers hardness (H) of the linear friction joined interface 12, the Vickers hardness (H₁) of the one member 2, and the Vickers hardness (H₂) of the other member 4 satisfy the relationship of 0.8 [(H₁+H₂)/2]≤H≤1.2 [(H₁+H₂)/2].

In tailored blank materials 10 in which metal materials having different strengths are joined, from the viewpoint of imparting good formability, it is preferable that the hardness of “the one member˜joined portion˜the other member” changes smoothly and continuously (not to make the joined portion a singular point). Here, when the Vickers hardness (H) of the joined portion is in the range of 0.8 to 1.2 times (more preferably in the range of 0.9 to 1.1 times) the average value of the Vickers hardness (H₁) of the one member 2 and the Vickers hardness (H₂) of the other member 4, it is possible to effectively prevent the joined portion from becoming a singular point.

The width of the linear friction joined interface 12 is extremely thin, approximately 0.2 to 2.0 mm, although it depends on the linear friction-joining conditions, so there are cases where it is difficult to measure the hardness of only the interface area. Therefore, for the Vickers hardness (H) of the joined portion, a value obtained by determining the measurement position so that the indenter of the Vickers hardness meter is approximately at the center of the linear friction joined interface may be used.

### (3) Press-Molded Article

FIG. 6 is a schematic cross-sectional view which shows one example of the press-molded article of the present invention. The press-molded article 20 is characterized in that the linear friction joined portion 14 of the tailored blank material 10 is plastically deformed.

The linear friction joined portion 14 is not a singular point of the tailored blank material 10 from the viewpoint of mechanical properties, and has good formability. As a result, the press-molded article 20 has no crack or wrinkle in the plastically deformed linear friction joined portion 14, and has a good appearance and high reliability.

The type and size of the plastic working applied to the linear friction joined portion 14 are not particularly limited as long as the effects of the present invention are not impaired, and may be appropriately determined depending on the desired shape of the press-molded article 20 and the like.

Although the typical embodiments of the present invention have been described above, the present invention is not limited to these, and various design changes are possible, and all of these design changes are included in the technical scope of the present invention.

### EXAMPLE

### Example

As the materials to be joined, three types of high-strength steel sheets having different strength levels of 590 MPa class high strength steel sheet (precipitation strengthened steel, 0.07% C-0.02% Si-1.87% Mn-0.015% P-0.003% S), 980 MPa class high strength steel sheet (DP steel, 0.113% C-0.941% Si-2.09% Mn-0.018% P-0.002% S) and 1250 MPa class high strength steel sheet (martensitic steel, 0.15% C-0.18% Si-1.23% Mn-0.016% P-0.004% S) were used.

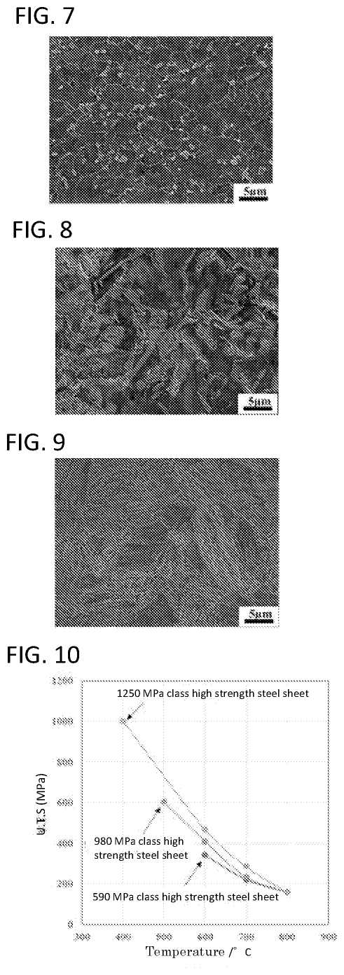

The base material structure of the 590 MPa class high strength steel sheet is shown in FIG. 7, the base material structure of the 980 MPa class high strength steel sheet is shown in FIG. 8, and the base material structure of the 1250 MPa class high strength steel sheet is shown in FIG. 9, respectively. The 590 MPa class high strength steel sheet has a microstructure including ferrite and cementite, the 980 MPa class high strength steel sheet has a microstructure including ferrite and martensite, and the 1250 MPa class high strength steel sheet has a microstructure including martensite.

The steel sheets were all 2 mm×80 mm×62.5 mm in size, and the end faces of 2 mm×80 mm of the sheets were butted each other and subjected to the linear friction-joining. The combinations of the materials to be joined were the dissimilar metal joining of the 590 MPa class high strength steel sheet and the 980 MPa class high strength steel sheet (590/980 joint), and the dissimilar metal joining of the 590 MPa class high strength steel sheet and the 1250 MPa class high strength steel sheet (590/1250 joint).

Further, in order to determine the joining pressure for the linear friction-joining, the temperature dependence of the strength of three types of high-strength steel sheets were researched. FIG. 10 shows the results of measuring the tensile strength at a temperature of 400 to 800° C. at a strain rate of 1.0/s. In addition to lowering the joining temperature as low as possible, in order to sufficiently discharge both materials to be joined as burrs from the vicinity of the interface to be joined, the joining pressure was set at 250 MPa. The temperature at which burrs are formed in the linear friction-joining with a joining pressure of 250 MPa is approximately 650° C. for the 590 MPa class high strength steel sheet, approximately 670° C. for the 980 MPa class high strength steel sheet, and approximately 710° C. for the 1250 MPa class high strength steel sheet.

The conditions of the linear friction-joining other than the joining pressure were kept constant at frequency: 30 Hz, amplitude: 1 mm, and burn-off length: 2.7 mm, and a 590/980 joint and a 590/1250 joint were obtained.

### Comparative Example

The comparative 590/980 joint and the comparative 590/1250 joint were obtained in the same manner as in the example except that the laser welding was used instead of the linear friction-joining.

The laser welding was performed in the atmosphere by using a disk laser, and setting laser output: 4 KW, welding speed: 6 m/s, and laser spot diameter: 340 μm.

### [Evaluation]

### (1) Macro Observation of the Cross-Section of the Joint

A cross-section sample of each of the obtained joints was prepared, and after subjected to mirror-polishing, observed with an optical microscope.

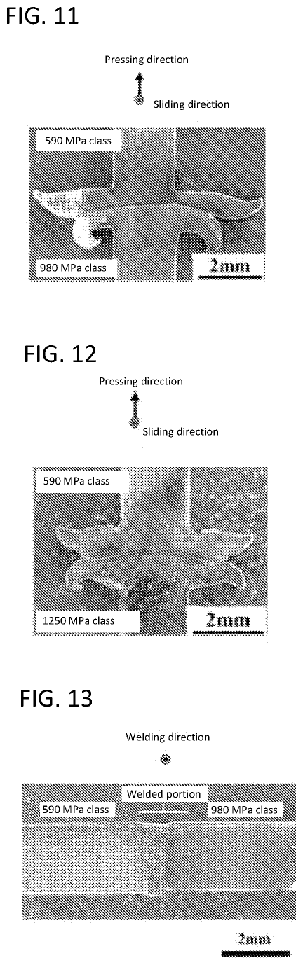

A cross-sectional macro photograph of the 590/980 joint is shown in FIG. 11, and a cross-sectional macro photograph of the 590/1250 joint is shown in FIG. 12, respectively. It can be seen that in all joints, sufficient burrs were discharged from both materials to be joined, and good solid phase joined portions with no defects were formed.

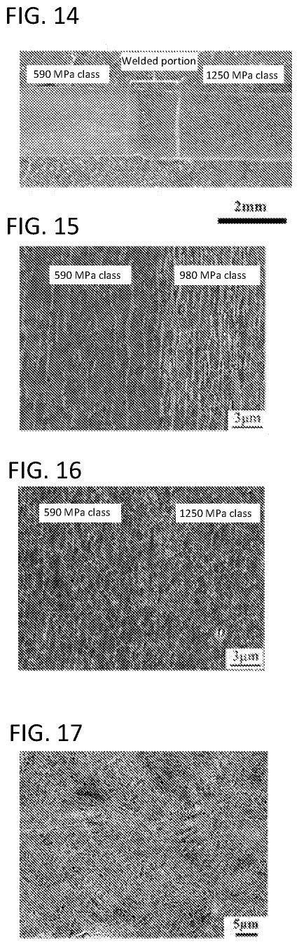

A cross-sectional macro photograph of the comparative 590/980 joint is shown in FIG. 13, and a cross-sectional macro photograph of the comparative 590/1250 joint is shown in FIG. 14, respectively. Good laser welded portions were formed in all joints, and no welding defects were observed.

### (2) Observation of the Microstructure of the Joint

In order to confirm the condition of the joined interface, a cross-sectional sample of the joined portion was observed by SEM. After polishing and corroding (4% Nital) the cross section, the structure was observed in more detail by using a scanning electron microscope (FE-SEM, JEOL JSM-7001FA). Note that, Emery paper (#600 to #3000) and diamond paste (particle size 3 μm and 1 μm) were used for polishing. A sample for observing the parent material was also prepared in the same manner.

FIG. 15 shows a photograph of the microstructure in the vicinity of the linear friction joined interface of the 590/980 joint. The microstructure on the 590 MPa class high strength steel sheet side includes ferrite and a small amount of martensite, and the microstructure on the 980 MPa class high strength steel sheet side includes ferrite and martensite. These microstructures indicate that the linear friction joining temperature was near the point A₁. It can also be seen that there is no minute defect at the linear friction joined interface.

FIG. 16 shows a photograph of the microstructure in the vicinity of the linear friction joined interface of the example 590/1250 joint. The microstructures of the 590 MPa class high strength steel sheet side and the 1250 MPa class high strength steel sheet side were both composed of ferrite and fine cementite, which indicates that the linear friction joining temperature was the A₁ point or less. Further, there are no minute defect at the linear friction joined interface. Here, the A₁ point is for the 590 MPa class high strength steel sheet: 660° C., for the 980 MPa class high strength steel sheet: 668° C., and for the 1250 MPa class high strength steel sheet: 693° C., from the viewpoint of the temperature dependance of the strength of each steel sheet shown in FIG. 10, the real joining temperature and the A₁ point are close to each other, and in the case of the example 590/1250 joint, it is thought that the both joining temperatures are the A₁ point or lower for both materials.

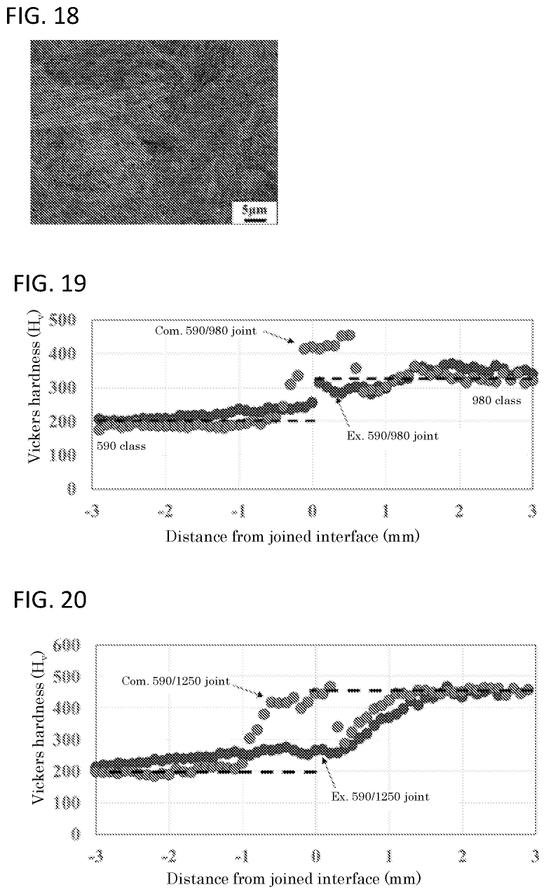

Microstructure photographs of the welded portions of the comparative 590/980 joint and the comparative 590/1250 joint are shown in FIG. 17 and FIG. 18, respectively. When the laser welding is performed, the microstructures including only of martensite are formed in both welded portions.

### (3) Vickers Hardness Measurement

Vickers hardness measurement was performed on the cross section of the joined portion of each joint obtained in the above examples and comparative examples. ARS 10K available from FUTURE-TECH was used as the measuring device, and the measurement was carried out under the conditions of 1 kg and 10 seconds.

FIG. 19 shows the Vickers hardness distribution perpendicular to the joined interface in the cross section of the example 590/980 joint and the comparative 590/980 joint. The Vickers hardness of the 590 MPa class high strength steel sheet is approximately 200 Hv, and the Vickers hardness of the 980 MPa class high strength steel sheet is approximately 350 Hv. The Vickers hardness of the linear friction joined portion is between the values of both steel sheets, and the hardness of the 590 MPa class high strength steel sheet˜the linear friction joined portion˜the 980 MPa class high strength steel sheet changes gradually. The Vickers hardness of the linear friction joined interface is 250 Hv, which is between the Vickers hardness of the 590 MPa class high strength steel sheet and the Vickers hardness of the 980 MPa class high strength steel sheet, and the range is 0.8 to 1.2 times the average value of the Vickers hardness of the 590 MPa class high strength steel sheet and the Vickers hardness of the 980 MPa class high strength steel sheet.

On the other hand, a significant increase in hardness is observed in the joined portion of the comparative 590/980 joint due to the formation of martensite.

The hardness of the joined portion is approximately 100 Hv higher than the hardness of the 980 MPa class high strength steel sheet, and it can be seen that the joined portion is the singular point in mechanical properties.

The Vickers hardness distribution perpendicular to the linear friction joined interface in the cross section of the 590/1250 joint is shown in FIG. 20.

The Vickers hardness of the 590 MPa class high strength steel sheet is approximately 200 Hv, and the Vickers hardness of the 1250 MPa class high strength steel sheet is approximately 450 Hv. The Vickers hardness of the linear friction joined portion is between the values of both steel sheets, and the hardness of the 590 MPa class high strength steel sheet˜the linear friction joined portion˜the 1250 MPa class high strength steel sheet changes gradually. The Vickers hardness of the linear friction joined interface is 270 Hv, which is between the Vickers hardness of the 590 MPa class high strength steel sheet and the Vickers hardness of the 1250 MPa class high strength steel sheet, and the ranges is 0.8 to 1.2 times the average value of the Vickers hardness of the 590 MPa class high strength steel sheet and the Vickers hardness of the 1250 MPa class high strength steel sheet.

On the other hand, in the joined portion of the comparative 590/1250 joint, on the 590 MPa class high strength steel sheet side there is an increase in hardness mainly due to the formation of martensite, and on the 1250 MPa class high strength steel sheet side there is softening in the heat affected zone. Further, the hardness in the vicinity of the linear friction joined interface is higher than that of the 1250 MPa class high strength steel sheet. Therefore, it can be seen that the hardness of the joined portion of the comparative 590/1250 joint varies greatly, and the joined portion is the singular point in mechanical properties.

### (4) Evaluation of Formability (Erichsen Test)

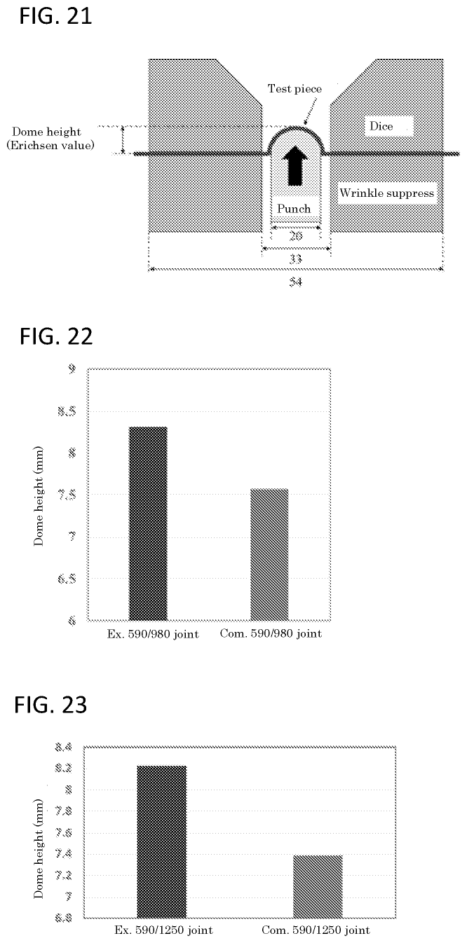

In order to evaluate the formability of each joint obtained, the Erichsen test was conducted. A schematic diagram of the Erichsen test conducted is shown in FIG. 21. The shape of the test piece was a rectangular plate with a thickness of 1.8 mm×a width of 80 mm×a length of 120 mm, and the joining line was placed at the center of the test piece. Note that burrs discharged from the joined portion of the linear friction joined joint were removed by using an emery paper (#80).

The Erichsen test was carried out by using an automatic universal deep drawing tester (JT TOHSI SAS-200D) under the conditions of a constant punching speed: 5 mm/s and a wrinkle suppressing force: 30 kN. The punch had a hemispherical shape having a diameter of 20 mm, and in order to cause the punch to break near the top, a 0.1 mm thick Teflon sheet was used as a lubricant. The dome height until the plastic deformation region breaks was measured to evaluate the formability of each joint.

The results of the example 590/980 joint and the comparative 590/980 joint are shown in FIG. 22, and the results of the example 590/1250 joint and the comparative 590/1250 joint are shown in FIG. 23, respectively. In either case, the example joints have a higher dome height than the comparative joints, and the example joints of the present invention have excellent formability. Note that the comparative joints were obtained by the laser welding, which provides the best formability among the fusion welding methods, and it can be seen that the joint of the present invention has superior formability compared to the tailored blank materials obtained by the conventional fusion welding.

### EXPLANATION OF SYMBOLS

2 . . . One member,
4 . . . Other member,
6 . . . Interface to be joined,
8 . . . Burr,
10 . . . Tailored blank material,
12 . . . Linear friction joined interface,
14 . . . Linear friction joined portion,
20 . . . Press-molded article.

1. A method for manufacturing a tailored blank material, characterized in that
one member and the other member are subjected to linear friction-joining, and
a difference in tensile strength between the one member and the other member is set to 150 MPa or more.

2. The method for manufacturing a tailored blank material according to claim 1, wherein
assuming that a joining pressure applied at the linear friction-joining is P, a temperature at which the tensile strength of the one member becomes the P is T₁ (° C.), a temperature at which the tensile strength of the other member becomes the P is T₂ (° C.),
the P is set so that the difference between the T₁ and the T₂ is within 100° C.

3. The method for manufacturing a tailored blank material according to claim 1, characterized in that
the one member and/or the other member are steel sheets, and
the steel sheet has a tensile strength of 980 MPa or more.

4. The method for manufacturing a tailored blank material according to claim 1, characterized in that
the one member and/or the other member are galvanized steel sheets.

5. The method for manufacturing a tailored blank material according to claim 3, characterized in that
the joining temperature is set to a point A₁ or less of the steel sheet.

6. A tailored blank material which comprises
a linear friction joined portion where one member and the other member are integrated via a linear friction joined interface, and
a difference in tensile strength between the one member and the other member is 150 MPa or more.

7. The tailored blank material according to claim 6, wherein
the one member and/or the other member are steel sheets, and
the steel sheet has a tensile strength of 980 MPa or more.

8. The tailored blank material according to claim 6, wherein the one member and/or the other member are galvanized steel sheets.

9. The tailored blank material according to claim 6, wherein the Vickers hardness (H) of the linear friction joined interface is 1.1 times or less of the higher of the Vickers hardnesses of the one member and the other member, and 0.9 times or more of the lower of the Vickers hardnesses of the one member and the other member.

10. A tailored blank material according to claim 6, wherein the Vickers hardness (H) of the linear friction joined interface, the Vickers hardness (H₁) of the one member, and the Vickers hardness (H₂) of the other member satisfy the relationship of the following Equation (1).
$$0.8 [ ( {H}_{1} + {H}_{2} ) / 2 ] \leq H \leq 1.2 [ ( {H}_{1} + {H}_{2} ) / 2 ] \qquad ( 1 )$$

11. A press-molded article, characterized in that the linear friction joined portion of the tailored blank material according to claim 6 is plastically deformed.
